(19) United States
(12) Patent Application Publication
(10) Pub. No.: US 2011/0047550 A1
(43) Pub. Date: Feb. 24, 2011

(54) SOFTWARE PROGRAM EXECUTION DEVICE, SOFTWARE PROGRAM EXECUTION METHOD, AND PROGRAM

(76) Inventor: MAKOTO TACHIBANA, Tokyo (JP)

Correspondence Address: Mr. Jackson Chen, 6535 N. STATE HWY 161, IRVING, TX, 75039, US

(21) Appl. No.: 12/851,364

(22) Filed: Aug. 5, 2010

(30) Foreign Application Priority Data
Aug. 24, 2009 (JP) 2009-193474

(51) Int. Cl. G06F 9/46

(52) U.S. Cl. 718/100

(57) ABSTRACT

The present invention provides a software program execution device which can accept a processing request even during a setting change of a software program without interrupting the processing in-execution. An execution monitoring unit monitors, in processing units and based on an instruction of a software program control unit, the operation of a server application unit which executes a software program in a process, and notifies a software program control unit that the processing being executed in a first process is completed. Upon receiving the notification, the software program control unit stops and then restarts the first process, and the first process is restarted while reflecting the setting change recorded in a setting storage unit during the restart step.

### CROSS-REFERENCES

This application is based upon and claims the benefit of priority from Japanese patent application. No. 2009-193474, filed on Aug. 24, 2009, the disclosure of which is incorporated herein in its entirety by reference.

### BACKGROUND

The present invention relates to a software program execution device, a software program execution method, and a program.

Generally a software program can control the operation of the program by setting the program at startup. For example, in the case of an application created by Java®, a character string “-Xmx” is specified when the software program is started, then a size of heap (memory area), which this software program can secure at maximum, can be controlled.

A software program in this case refers to software which receives a processing request from a user, and executes a certain processing. The software program can accept a request from the user by starting up a process to operate the program. The software program includes transaction processing. The transaction processing is a so called “on-line real-time processing”, which allows to process provided information immediately, and receive the result at required places. The side which requests the processing is called a “client”, and the side which executes the requested processing and returns the result is called a “server”, and generally, a client application (client application program) is installed in a terminal device side, and a server application (server application program) is installed in a host computer side, which is connected to the terminal device via a communication line.

Generally the setting of a software program can be specified only when the software program is started, and cannot be changed after the software program has started. To change the setting of the software program, the process in which the software program is running must be stopped once and restarted after specifying a new setting. In this case, processing requests from the user cannot be accepted while the process in which the software program is running is being stopped. If the process in which the software program is running is stopped while processing a software program, the processing in mid-execution is interrupted.

A known solution to such problems is to include a setting change means in the software program (e.g. Japanese Patent Application Laid-Open No. 2002-297535). In this method, the software program includes means for accepting a setting change request and means for changing a setting, so that a setting change request is accepted from the user during startup, and the change of setting is reflected in the software program. By this method, the setting information can be changed without stopping the process in which the software program is running.

However, the software program is generally created using an already available key technology, and if this key technology comes from an outside source, then in many cases the programmer of the software program cannot modify this key technology portion. In other words, setting for controlling this key technology portion cannot be changed by the setting change means inside the software program, as disclosed in Japanese Patent application Laid-Open No. 2002-297535. In the case of the above mentioned program created with Java®, for example, the programmer of the software program that runs on a Java® VM (Virtual Machine) generally cannot modify the key portion of Java®, and therefore the user cannot modify the setting of the key portion of the Java® VM, such as for the heap size. In other words, even if the software program that runs on a Java® VM includes means for accepted a setting change request or a means for changing the setting, setting of the key portions of Java® VM cannot be changed. Since a Java® VM reads a setting during startup, the user can specify the setting only when the Java® VM is started up.

Another possible method for changing the setting of a software program is using what is called “clustering software”. Normally clustering software refers to a software for monitoring the failure of a system and having another server take over operation when a failure occurs, so as to implement high availability, and is also used to perform maintenance which requires a stoppage of applications, while continuing services. Clustering software has a start/stop function for a server computer, a function to control active/inactive of a virtual IP address, and can switch routing to another server when the server computer is restarted.

The clustering software, however, normally controls in server machine units, and the scale of the control target is large. It is possible to create an environment of a plurality of control targets in one server machine, but it is necessary to assign a virtual IP address to each target, and perform centralized control for active/inactive, and control at a small scale, such as in process units, is difficult. Further, in clustering software, multiplexing at a large scale, such as in server machine units, is required, and the resource consumption of disks and memories is high, and restarting takes time.

Moreover, the clustering software normally operates outside the application server, so monitoring the execution state of an application is difficult. In the case of restarting each application server, it is necessary to monitor the execution state of all software programs, but whether this is possible or not depends on the installation of the application server. The time required for monitoring also takes time, since there are many monitoring targets.

How to handle the requests held in a queue inside the application server is also different. In the case of clustering software, the completion of execution of the requests held in a queue must be “waited”, which takes time, in this aspect as well, to also reflect the setting in the software program.

### SUMMARY

An exemplary object of the invention is to change the setting of a software program while maintaining a state where the software program can accept processing requests, and not to interrupt the processing of software programs while changing the setting.

It is another object of the present invention to change the setting of a software program dynamically even if the content thereof cannot be modified.

A software program execution device according to an exemplary aspect of the invention has: a setting storage unit which records a setting change request for a software program that is input by a user; a program execution unit which executes the software program in a process in which the setting change recorded in the setting storage unit has been reflected at startup, according to a processing request that is input by the user; a software program control unit which controls the start and stop of the program execution unit in units of the process; a queue control unit which holds processing requests from the user to the program execution unit in a queue; a dequeue unit which is provided corresponding to the process, so as to fetch the processing request from the queue and notify the process of the processing request; and an execution monitoring unit which monitors an operation of the program execution unit in units of the process, wherein if the user inputs the setting change request for the software program, the execution monitoring unit monitors a first process corresponding to the software program based on an instruction of the software program control unit, and when processing being executed in the first process is completed, notifies the software program control unit of this completion, and upon receiving the notification, the software program control unit stops and then restarts the first process.

### DESCRIPTION OF THE DRAWINGS

FIG. 1 is a block diagram depicting a configuration of a transaction system including a server computer (software program execution device) according to an exemplary embodiment of the present invention;

FIG. 2 is a block diagram depicting a configuration of a server computer according to an exemplary embodiment of the present invention; and

FIG. 3 is a flow chart depicting an operation of the server computer according to an exemplary embodiment of the present invention.

### EXEMPLARY EMBODIMENT

An exemplary embodiment of the present invention will now be described with reference to the drawings.

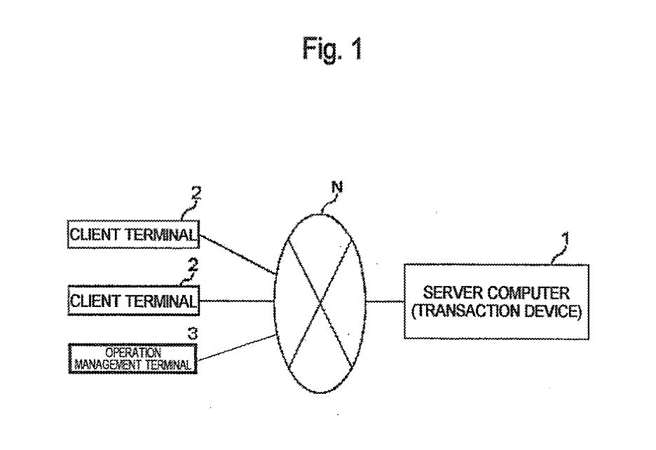

FIG. 1 is a block diagram depicting a configuration of a transaction system including a server computer (software program execution device) 1 according to an exemplary embodiment of the present invention. As FIG. 1 shows, the transaction system has a server computer 1 (transaction device) which executes transactions, a plurality of client terminals 2 which are connected with the server computer 1 via a network N, and an operation management terminal 3.

In the transaction system according to the present embodiment, the server computer 1 receives a processing request which is sent from the client terminal 2, executes a transaction based on the request that the server computer 1 received, and sends the respond to the client terminal 2. An arbitrary information can be transmitted/received between the operation management terminal 3 and the server computer 1 via the network N. The system to which the server computer 1 according to the present embodiment is applied is not limited to the mode shown in FIG. 1, but can be any system in which the server computer 1 receives a processing request, executes a transaction, and sends a response.

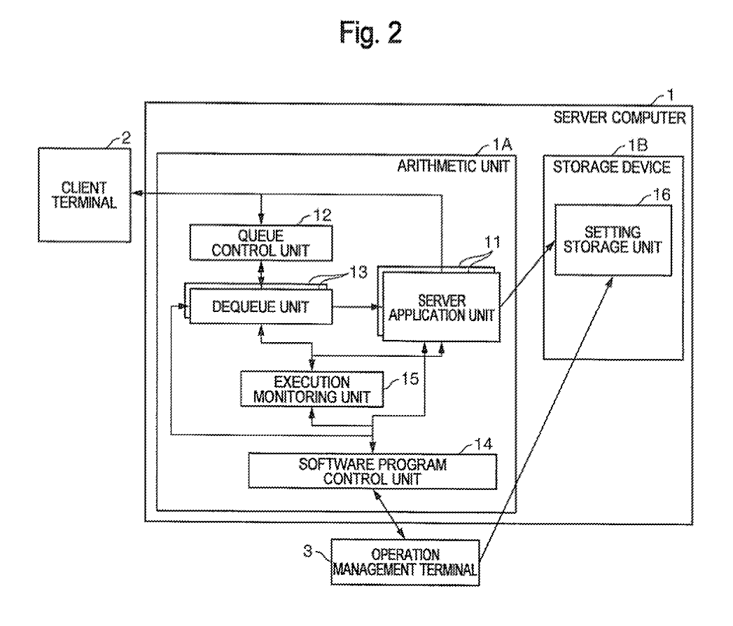

FIG. 2 is a block diagram depicting the configuration of the server computer 1. As FIG. 2 shows, the server computer 1, which is a transaction device, has a basic computer configuration, that is, an arithmetic unit 1A, such as a CPU, and a storage device 1B, such as a hard disk.

The arithmetic unit 1A has a server application unit (program execution unit) 11, a queue control unit 12, a dequeue unit 13, a software program control unit 14, and an execution monitoring unit 15. The server application unit 11, queue control unit 12, dequeue unit 13, software program control unit 14, and execution monitoring unit 15 have modules for operations which the processor of the computer executes according to the program, and these units are integrated and implement the functions of the arithmetic unit 1A.

The server application unit 11 executes a transaction processing (software program) according to the request from the client terminal 2 during a process. The server application unit 11 and the dequeue unit 13 are constructed by the number of processes which run in parallel. The queue control unit 12 is created for each type of software program that is executed by the server computer 1. For example, if one type of software program is executed by the server computer 1, which is being operated in two-process multiplexing, then two server application units 11 and two dequeue units 13 are disposed, and one queue control unit 12, one software program control unit 14 and one execution monitoring unit 15 are disposed.

The storage device 1B has a setting storage unit 16. In the setting storage unit 16, the setting content of the software program is stored. If a setting change request is received from a user via the operation management terminal 3, the arithmetic unit 1A changes the stored setting content.

In the arithmetic unit 1A, other functions required for transactions and other functions of a general server computer have also been installed, and in the storage device 1B as well, other necessary information has been stored, but description thereof is omitted.

The configuration of the server computer 1 will be described in detail here.

The server application unit 11 executes transaction processing requested by the client terminal 2.

The queue control unit 12 receives and holds a processing request which is sent from the client terminal 2 via the network N. In the server application unit 11, an upper limit number of transactions, that can be processed simultaneously in the running process, is set. If a number of requests exceeding this upper limit are simultaneously received, the requests exceeding the limit are stored in the queue control unit 12.

The dequeue unit 13 controls the execution of transaction processing in the corresponding server application unit 11. In concrete terms, when it is confirmed, via the execution monitoring unit 15, that the server application unit 11 is in a state in which a transaction processing can be executed, the dequeue unit 13 fetches a processing request to be executed next from the queue control unit 12, and notifies the server application unit 11 of the processing request to start the transaction processing based on this processing request. The notification of the execution result of the transaction processing may be issued to the client terminal 2, and may be issued via the queue control unit 12 in this case.

The software program control unit 14 controls the start and stop of the server application unit 11 and the dequeue unit 13 in process units.

The execution monitoring unit 15 manages the execution state of the server application unit 11, that is, the number of transactions currently being executed, for each process. When the server application unit 11 starts or completes a requested processing, this information is transferred to the execution monitoring unit 15. If the number of transactions being executed in the corresponding server application unit 11, obtained via the execution monitoring unit 15, is the same as the upper limit of simultaneously processable transactions in the process, the dequeue section 13 waits until an opening is created without dequeuing.

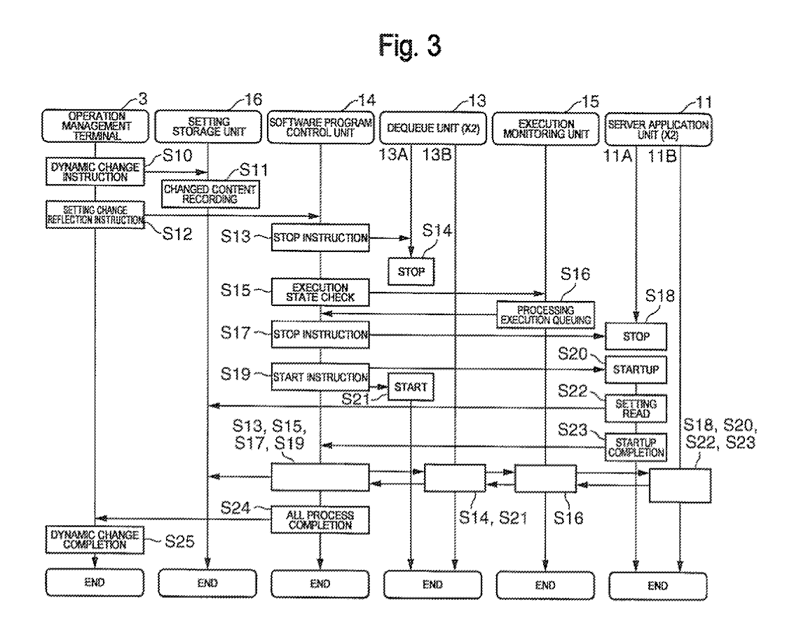

An operation of the server computer 1 according to the present embodiment will now be described with reference to FIG. 3.

First the user sends a setting change instruction via the operation management terminal 3 (step S10). When the server computer 1 receives the setting change instruction, the arithmetic unit 1A changes the setting content recorded in the setting storage unit 16 (step S11).

When the change of the setting stored in the setting storage unit 16 is completed, the operation management terminal 3 instructs the software program control unit 14 to reflect the setting change in the server application (step S12). The software program control unit 14 reflects the setting change for a part of the processes of a plurality of server application units 11 which are running. For example, if two server application processes of the server application unit 11A and the server application unit 11B are running, the setting change is reflected on the server application unit 11A first.

The software program control unit 14 sends a stop instruction to the dequeue unit 13A corresponding to the server application unit 11A, on which the setting change is reflected (step S13). The dequeue unit 13A receives the stop instruction and stops (step S14). Then the software program control unit 14 has the execution monitoring unit 15 monitor the execution state of the server application unit 11A (step S15).

The execution monitoring unit 15 stands by until the processing currently being executed in the server application unit 11A is completed, and when it becomes a state where all the processings are completed and no transaction processing is being executed in the server application unit 11A, the execution monitoring unit 15 notifies the software program control unit 14 of this state (step S16).

The software program control unit 14 sends a stop instruction to the server application unit 11A (step S17). The server application unit 11A receives the stop instruction and stops (step S18). When the stop of the server application unit 11A is confirmed, the software program control unit 14 sends a start instruction to the server application unit 11A and the dequeue unit 13A (step S19). The server application unit 11A receives the start instruction and starts the startup process (step S20). The dequeue unit 13A also receives the start instruction and starts up (step S21). The server application unit 11A reads the setting changed in step S11 in the startup processing step (step S22).

When startup processing completes, the server application unit 11A notifies the software program control unit 14 of this completion (step S23). Whereby the reflection of the setting change on the server application unit 11A is completed. If a processing request is sent from the client terminal 2 while processings from step S13 to step S23 are executed, the processing request is held in the queue control unit 12. Then after the server application unit 11A and the dequeue unit 13A are restarted, and the processing request is fetched by the dequeue unit 13 and is executed by the server application unit 11A.

Then the processings in step S13 to step S23 are executed for the server application unit 11B in the same manner as the server application unit 11A. When it is confirmed that the processings in step S13 to step S23 are completed for all the server application processes (two processes: 11A and 11B in this case) (step S24), the software program control unit 14 notifies the operation management terminal 3 of this completion. Whereby the reflection of the setting change on all the server application units is completed (step S25).

As described above, according to the present embodiment, if a setting change for the server application unit 11 is requested, the execution monitoring unit 15 monitors the execution state of the server application unit 11 in the units of the server application process based on the instruction of the software program control unit 14, and the server application unit 11 is restarted in process units only after the processing being executed in a process is completed and no more transaction processings are executed, therefore a setting can be changed dynamically without interrupting the transaction processing, even for a software program in which a setting change is difficult during startup, as in the case of using an external key technology.

While reflecting the setting change on the server application unit 11A, a processing request from the client terminal 2 is held in the queue control unit 12, and after the server application unit 11A is restarted, the dequeue unit 13A fetches the processing request from the queue control unit 12, and notifies the server application unit 11A of the processing request, and the server application unit 11A executes the processing. Therefore a setting can be changed while maintaining the state in which the software program can accept processing requests.

Since the software program control unit 14 sequentially stops and restarts a plurality of processes, a processing request from the client terminal 2 can be executed in the server application unit 11B even while changing the setting for the server application 11A. In the same manner, a processing request from the client terminal 2 can be executed in the server application 11A while changing the setting for the server application 11B.

Further, the dequeue unit 13 is stopped before stopping the process, which prevents the state where a processing request is received from the client terminal 2 during process stopping processing, and the execution of the request processing fails.

In order to implement a dynamic change without decreasing the processing amount that can be processed at once, in other words, in order to maintain the server applications in two processes in an operable state, the process startup processing in step S20 to step S23 may be executed before executing the processing from step S13 to step S18. In other words, the server application unit 11C, which has read the setting after the change, is started up so that three processes are running temporarily, then the server application unit 11A or 11B, which is running under an old setting, is stopped and restarted. Whereby two server application processes can always be operated even while the server application unit 11A or 11B is stopping. The two processes of the server application unit 11C and 11D may be newly started up, so as to stop the two processes of the server application units 11A and 11B all at once.

According to the present invention, the setting of a software program can be changed while maintaining a state where the software program can accept processing requests.

An exemplary advantage according to the invention, processing of the software program is not interrupted while changing the setting.

Further, according to the invention, the setting of a software program can be changed dynamically even if the content thereof cannot be modified.

Moreover, according to the invention, it is sufficient if only the program execution unit and the dequeue unit are multiplexed, thereby providing excellent characteristics in that the utilization efficiency of resources, such as disks and memories, is higher than that of clustering software, and the time required for reflecting the setting change can be decreased.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A software program execution device, comprising:
a setting storage unit which records a setting change request for a software program that is input by a user;
a program execution unit which executes the software program in a process in which the setting change recorded in the setting storage unit has been reflected at startup, according to a processing request that is input by the user;
a software program control unit which controls the start and stop of the program execution unit in units of the process;
a queue control unit which holds processing requests from the user to the program execution unit in a queue;
a dequeue unit which is provided corresponding to the process, so as to fetch the processing request from the queue and notify the process of the processing request; and
an execution monitoring unit which monitors an operation of the program execution unit in units of the process, wherein
if the user inputs a setting change request for the software program, the execution monitoring unit monitors a first process corresponding to the software program based on an instruction of the software program control unit, and when processing being executed in the first process is completed, notifies the software program control unit of this completion, and
upon receiving the notification, the software program control unit stops and then restarts the first process.

2. The software program execution device according to claim 1, wherein
when a plurality of the processes are in execution, the software program control unit sequentially stops and restarts each of the processes.

3. The software program execution device according to claim 1, wherein
upon receiving the notification, the software program control unit stops and then restarts the first process after starting a second process corresponding to the software program.

4. The software program execution device according to claim 1, wherein
the software program control unit stops the dequeue unit corresponding to the process before stopping the process.

5. A software program execution method, comprising steps of:
recording, in a setting storage unit, a setting change request for a software program that is input by a user;
an execution monitoring unit monitoring, in process units and based on an instruction of a software program control unit, an operation of a program execution unit which executes a software program in a process, and when processing being executed in a first process corresponding to the software program is completed, notifying the software program control unit of this completion;
the software program control unit, upon receiving the notification, stopping and then restarting the first process; and
the first processing being started while reflecting the setting change recorded in the setting storage unit during the restart step.

6. A program for causing a computer to function as:
a program execution unit which executes a software program in a process in which a setting change recorded in a setting storage unit has been reflected at startup, according to a processing request that is input by a user;
a software program control unit which controls the start and stop of the program execution unit in units of the process;
a queue control unit which holds processing requests from the user to the program execution unit in a queue;
a dequeue unit which is provided corresponding to the process, so as to fetch the processing request from the queue and notify the process of the processing request; and
an execution monitoring unit which monitors an operation of the program execution unit in units of the process, wherein
if the user inputs a setting change request for the software program, the execution monitoring unit monitors a first process corresponding to the software program based on an instruction of the software program control unit, and when processing being executed in the first process is completed, notifies the software program control unit of this completion, and
upon receiving the notification, the software program control unit stops and then restarts the first process.
